(19) United States
(12) Patent Application Publication
(10) Pub. No.: US 2026/0328479 A1
(43) Pub. Date: Oct. 22, 2026

(54) INJECTOR-BURNER FOR FURNACE, IN PARTICULAR FOR THE PRODUCTION OF STEEL OR METALS

(71) Applicant: SMS GROUP S.p.A., Tarcento (Udine) (IT)

(72) Inventors: Fabio VECCHIET, Tarcento (Udine) (IT); Jacopo GREGUOLDO, Tarcento (Udine) (IT); Gabriele DAPIT, Tarcento (Udine) (IT); Cesare LAVIOSA, Tarcento (Udine) (IT)

(21) Appl. No.: 19/648,038

(22) Filed: Apr. 15, 2026

(30) Foreign Application Priority Data
Apr. 17, 2025 (IT) 102025000008700

(51) Int. Cl. F27D 99/00; C21C 5/46

(52) U.S. Cl. CPC F27D 99/0033; C21C 5/4606; C21C 2005/4626

(57) ABSTRACT

An injector-burner with axial-symmetric extension with respect to a longitudinal axis, defining a central nozzle, a first annular chamber, a second annular chamber, and a third annular chamber concentric to the central nozzle, has a main injector body on which are formed a head and the central nozzle, and an assembly of four concentric tubular bodies connected on the main injector body in positions axially and radially offset from one another. The main injector body is made of a first material. The tubular bodies are made of a second material. Three annular shoulders have each a lowered annular seat defined by a first surface transverse to the longitudinal axis and connected to a thickness of a wall of the tubular body at the head, and a second surface. A fill of a material compatible in welding with the first and second materials occupies a recess on the main injector body.

### CROSS REFERENCE TO RELATED APPLICATION

This application claims priority to and benefit of Italian Patent Application No. 102025000008700 filed Apr. 17, 2025, the contents of which are incorporated by reference in their entirety.

### FIELD OF THE INVENTION

The subject of the present invention is an injector-burner for furnaces, in particular for the production of steel or metals, for example electric arc furnaces.

### BACKGROUND OF THE INVENTION

In the field of furnaces, for example electric arc furnaces, for use in the steel and metal industry, it is known to make openings on the side walls of the furnace chamber, through which devices such as burners, injectors, and lances can be inserted.

In particular, it is known to use auxiliary burners that allow additional energy to be added to the energy supplied by the electric arc in order to facilitate and accelerate the melting of the metal.

It is also known to use injectors capable of introducing gas or granular material into the furnace chamber and into the bath of molten metal and slag generated therein. They may be fixed to the wall or movable within the furnace by means of suitable manipulators (in this case they are sometimes referred to as lances). The injectors are often used to generate a supersonic gas flow or a high-speed jet of granular material. Injectors and lances, in addition to functioning as gas injectors or burners, allow additives to be introduced into the bath of molten metal, which are used during the metallurgical process, such as carbon, lime or other granular material. Auxiliary burners, injectors and lances will hereinafter be referred to as “injectors”.

These injectors, in order to achieve maximum effectiveness, must be positioned inside the furnace as close as possible to the melting bath. In this configuration, the injectors are intended to operate at the working temperature of the furnace, which may reach 1500 °C-1700 °C, and are also exposed to possible splashes of liquid steel and slag. For these reasons, these injectors are internally provided with forced water cooling circuits.

The operating conditions of these injectors are therefore very severe and cause them to wear out very quickly. Significant levels of wear or, at the limit, the breakage of the injector due to thermo-mechanical stress can cause a leakage of water from the internal cooling circuit into the furnace, resulting in a deterioration of the operating conditions.

Moreover, any water infiltration into the molten bath and below the layer of refractory material can cause the formation of steam, which results in a rapid increase in volume and pressure with the effect of a real explosion.

In addition, the wear of the injector or the formation of cracks in its parts entails the risk of leaks occurring within the circuits of the fuel and/or the combustion agent that are delivered into the furnace by the injector. In this case, the gaseous fuel (for example, methane) and the combustion agent (in particular, oxygen) would no longer be mixed in the area designated for combustion inside the furnace, but would mix upstream of the injector (or inside it), once again causing a serious risk of explosion.

From the above, it is therefore clear how important the following factors are:
high cooling efficiency suitable to reduce the thermo-mechanical stresses in the injector and thus reduce wear and the risk of crack formation or breakage;
a construction configuration that ensures high sealing between the internal ducts of the different fluids handled (gaseous fuel, combustion agent and water); and
ease of construction, in order to contain production costs and therefore the costs related to the replacement of worn injectors.

To all this is added the need to reduce as much as possible the weight and dimensions of the injectors in order to increase their manoeuvrability and thus facilitate the operations related to the transport, removal and installation of worn and new injectors in the furnace area.

The search for weight and size reduction must not, however, be pursued at the expense of the functionality and the containment of the production costs of the injector.

Typically, an injector comprises a head T having an axial-symmetric development, composed of several components, generally made of copper or steel and welded together. The head of the injector presents, from the axis outward, the following sequence of ducts/chambers:
a central duct C for the primary combustion agent which supplies a central nozzle U of the injector;
an annular chamber C1 for the gaseous fuel (for example, methane) which supplies a first circular series of nozzles D1 via respective ducts;
an annular chamber C2 for the secondary combustion agent which supplies a second D2 and possibly also a third circular series of nozzles D3 via respective ducts; and
an annular chamber C3 for water cooling.

This sequence of chambers/ducts may be implemented with various construction configurations.

According to a construction type known as “concentric tubes”, of which an example is illustrated in FIGS. 1 to 4, the injector is defined by four or more concentric tubular bodies which define, two by two, the annular chambers, including the cooling chamber. The tubular bodies are fitted at a first end onto the head of the injector where the nozzles are formed, while at a second end they are connected to respective supply ducts.

Generally, the annular chambers are separated from one another by sealing joints, in many cases made by welding. In the event of even a partial failure of the joints, dangerous fluidic short circuits may occur between fuel and combustion agent, with the risk of forming explosive mixtures. This problem is particularly significant in injectors of the “concentric tubes” type.

For these reasons, the known construction types of injectors require particularly laborious methods of implementation, especially of the sealing joints. All this, combined with the intrinsic construction complexity of the injectors (consisting of a multiplicity of parts assembled together), negatively affects production costs.

Compared to other types of injectors, the “concentric tubes” type—although afflicted by the aforementioned problems—represents the technically simplest and most economical construction solution to implement.

In the field of injectors for furnaces, in particular electric arc furnaces, the need is therefore still strongly felt to have injectors of the concentric tubes type with increased manoeuvrability, at the same time having construction features such as to maintain their functionality, without however increasing the complexity of implementation, and possibly even reducing it.

Other important factors to be considered in the implementation of injectors are related to:
the need to ensure efficient cooling of the head exposed to greater thermo-mechanical stresses, with a view to reducing wear and the risk of breakage; and
the need to ensure fluid dynamics favourable to combustion at the outlet of the injector.

In the field of injectors for furnaces, in particular electric arc furnaces, the need to have injectors of the concentric tubes type with increased manoeuvrability should preferably be associated with the need to continue to offer adequate cooling of the head, as well as to achieve fluid dynamic performance favourable to combustion.

### SUMMARY OF THE INVENTION

Therefore, the main object of the present invention is to eliminate, in whole or in part, the drawbacks of the known prior art mentioned above, by providing an injector-burner for furnaces, in particular for the production of steel or metals, for example electric arc furnaces, which can be constructed so as to be more manageable and more economical, while at the same time having construction features such as to maintain its functionality, without however increasing the complexity of implementation, and possibly even reducing it.

A secondary object of the present invention is to provide an injector-burner for furnaces, in particular for the production of steel or metals, for example electric arc furnaces, which, while being capable of being constructed so as to be more manageable and more economical, continues to allow efficient cooling of the head.

Another secondary object of the present invention is to provide an injector-burner for furnaces, in particular for the production of steel, for example electric arc furnaces, which, while being capable of being constructed so as to be more manageable and more economical, continues to offer fluid dynamic performance favourable to combustion.

### BRIEF DESCRIPTION OF THE DRAWINGS

The technical features of the present invention, according to the aforementioned objects, are clearly identifiable from the content of the claims set out below, and the advantages thereof will become more evident in the detailed description that follows, made with reference to the accompanying drawings, which represent one or more purely exemplary and non-limiting embodiments thereof, in which:

FIG. 1 shows a front perspective view of a traditional type injector-burner;

FIG. 2 shows a front orthogonal view of the injector-burner of FIG. 1;

FIG. 3 shows a sectional view of the injector-burner of FIG. 2 taken along the section plane A-A indicated therein;

FIG. 4 shows a sectional view of the injector-burner of FIG. 2 taken along the section plane B-B indicated therein;

FIG. 5 shows a front perspective view of an injector-burner according to a preferred embodiment of the invention;

FIG. 6 shows a front orthogonal view of the injector-burner of FIG. 5;

FIG. 7 shows a rear orthogonal view of the injector-burner of FIG. 5;

FIG. 8 shows a sectional view of the injector-burner of FIG. 6 taken along the section plane A-A indicated therein;

FIG. 9 shows a sectional view of the injector-burner of FIG. 5 taken along the section plane B-B indicated therein;

FIG. 10 shows an exploded view of the injector-burner of FIG. 5;

FIG. 11 shows a perspective view of a detail of the injector-burner of FIG. 10 relating to a main injector body;

FIG. 12 shows a detailed view of a detail of FIG. 8 relating to a welding joint area; and

FIG. 13 shows a detailed view of a particular of FIG. 8 relating to a welding joint area between the central nozzle and tubular body.

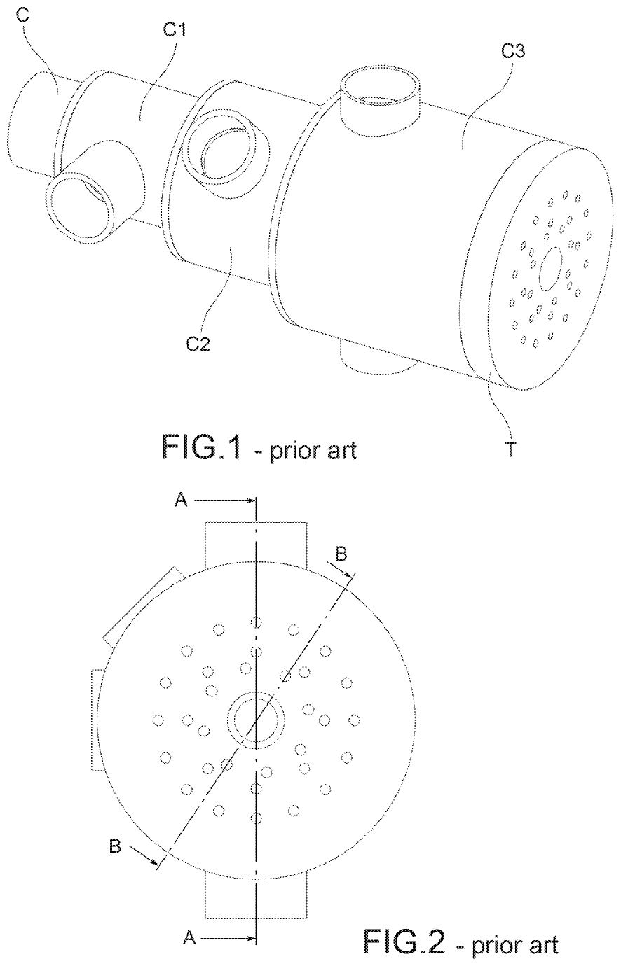

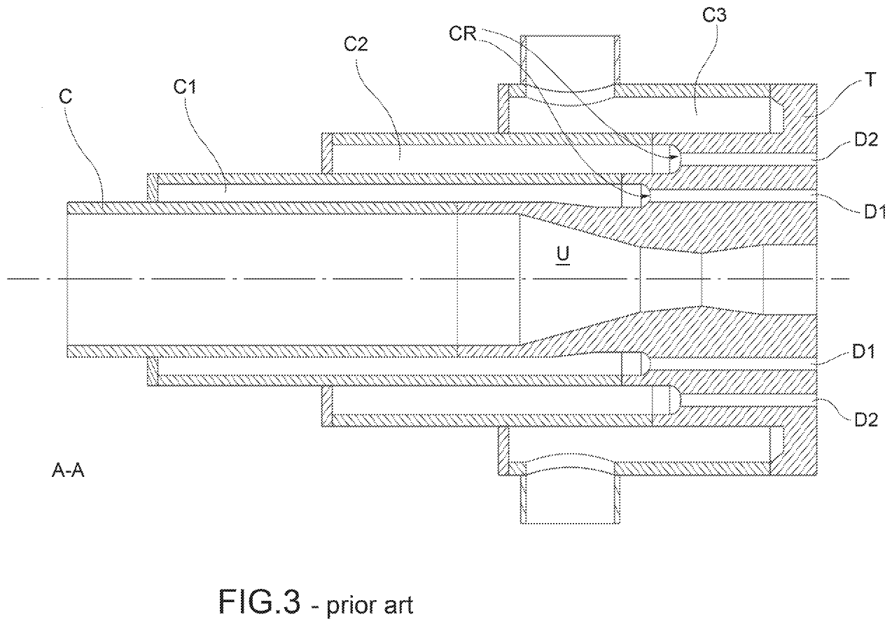

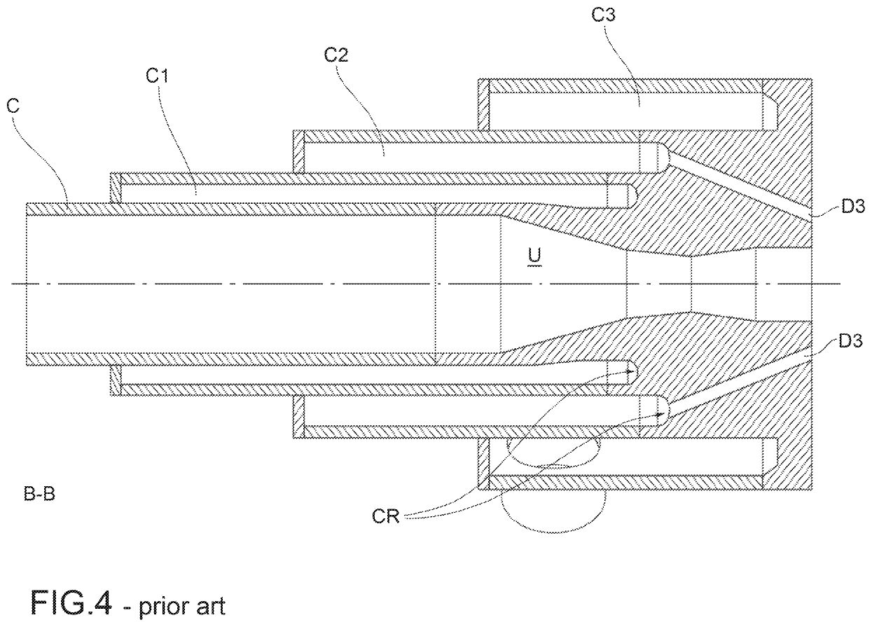

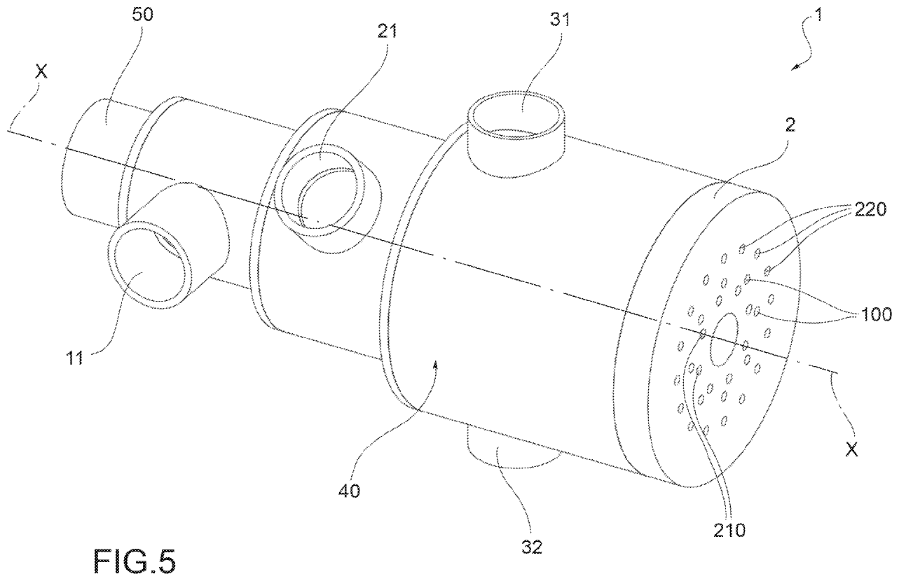

The figures constitute purely schematic representations of the object, without necessarily respecting the proportions between the various parts.

### DETAILED DESCRIPTION

The injector-burner for furnaces, in particular for the production of steel or metals according to the invention, is generally denoted by 1 in the attached figures.

In particular, the furnace is an electric arc furnace, but in general it may be an industrial furnace.

Here and in the following description and claims, reference will be made to the injector-burner 1 in its condition of use. In this sense, any references to a lower or upper position, front or rear, or to a horizontal or vertical orientation, are to be understood accordingly.

According to a general embodiment of the present invention, the injector-burner 1 has an axial-symmetric extension with respect to a longitudinal axis X.

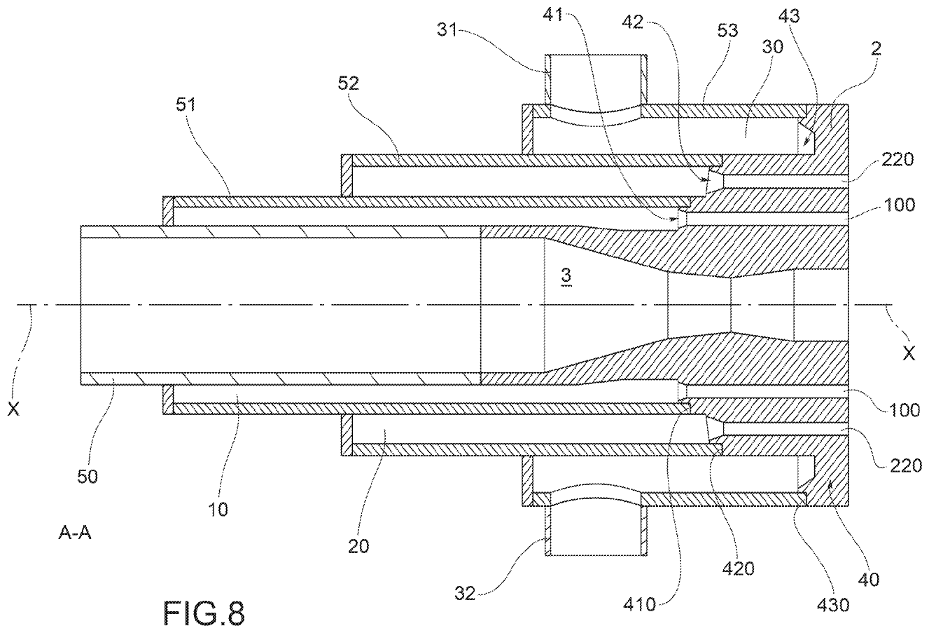

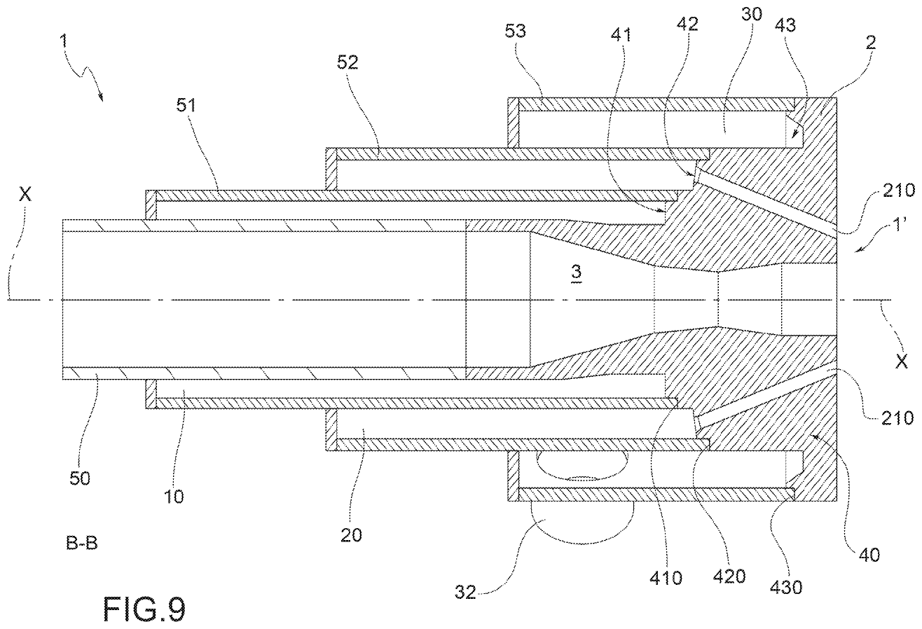

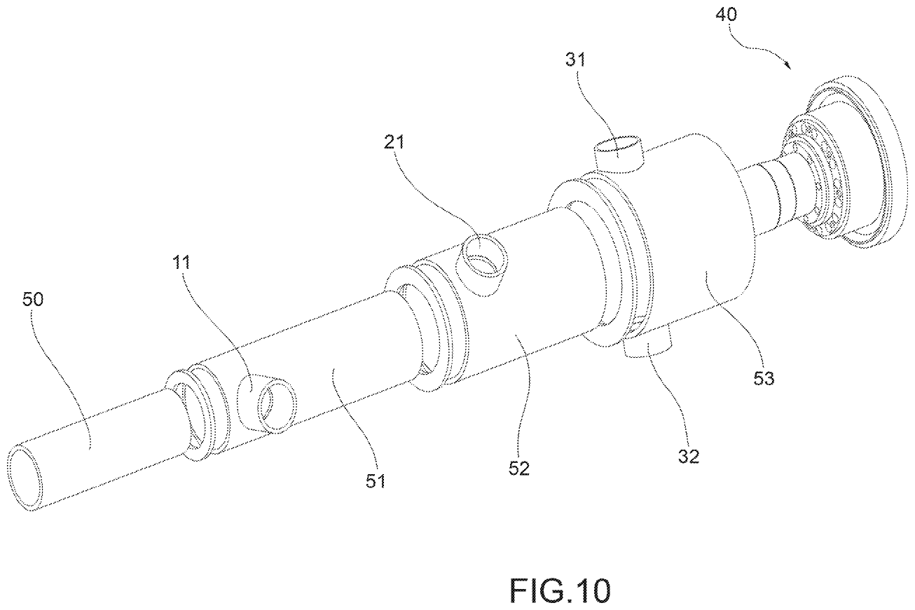

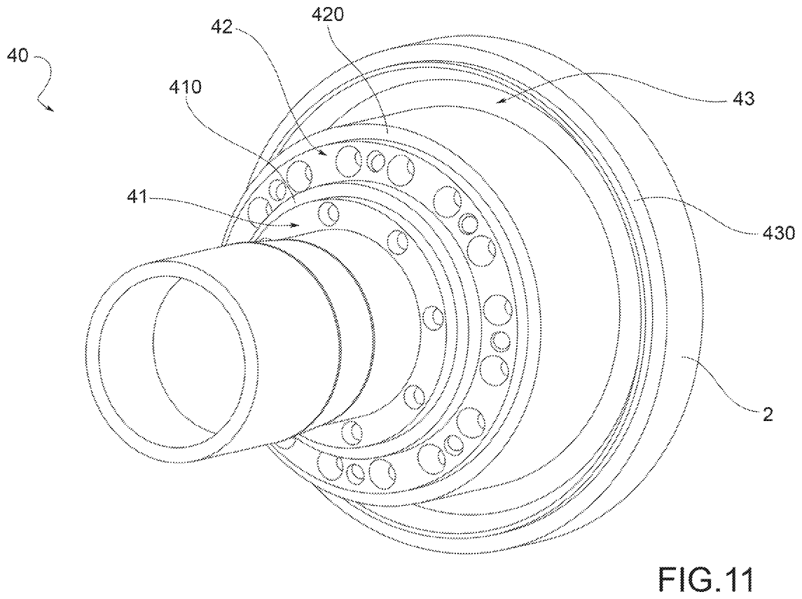

As shown in particular in FIGS. 8 and 9, the injector-burner 1 defines in sequence from the longitudinal axis X outwards:
a central nozzle 3, which is arranged along the longitudinal axis X and is intended to be fluidically supplied with a flow of primary combustion agent through a first supply duct 50;
a first annular chamber 10, which is intended to be fluidically supplied with a flow of gaseous fuel or with a flow of secondary combustion agent through at least a second supply duct 11;
a second annular chamber 20, which is intended to be fluidically supplied through a third supply duct 21 with a flow of secondary combustion agent, in the case where the first annular chamber 10 is supplied with a flow of gaseous fuel, or with a flow of gaseous fuel, in the case where the first annular chamber 10 is supplied with a flow of secondary combustion agent; and
a third annular chamber 30, which is intended to be fluidically connected to the delivery 31 and return 32 of a circulation circuit of a cooling fluid.

The gaseous fuel may be of any type suitable for the purpose, for example methane.

The primary combustion agent and the secondary combustion agent may be air, oxygen-enriched air, or pure oxygen, depending on the operating conditions of the injector-burner 1.

The cooling fluid may be of any type suitable for the purpose, preferably water.

As shown in particular in FIGS. 8 and 9, the injector-burner 1 comprises a main injector body 40 on which are formed:
a head 2, which is arranged at a first axial end 1′ of the injector-burner 1 and is intended to face the inside of a furnace, for example an electric arc furnace (not shown in the figures); and
the central nozzle 3 which extends axially in a position opposite to the head 2.

The head 2 is coaxially traversed by the central nozzle 3 and is provided with several circular series of nozzles 100, 210, 220 that connect the first annular chamber 10 and the second annular chamber 20 with the outside of the injector-burner 1.

Preferably, the main injector body 40 is made in a single piece. In particular, the main injector body 40 may be obtained from solid material from a single piece. Alternatively, the main injector body 40 may be produced by printing or additive manufacturing.

The injector-burner 1 comprises an assembly of four concentric tubular bodies 50, 51, 52, 53 which are sealingly connected by welding on the main injector body 40 in positions that are axially and radially offset from one another to define, two by two, the three annular chambers 10, 20, 30.

Of the four concentric tubular bodies 50, 51, 52, 53, the innermost tubular body 50 (which acts as the first supply duct) is connected to the central nozzle 3, while the other three tubular bodies 51, 52, 53 are coaxially external to the central nozzle 3.

The three annular chambers 10, 20 and 30 are therefore concentric to the central nozzle 3, configuring the injector-burner 1 as an injector-burner of the concentric tubes type.

The main injector body 40 is made of a first material, while the tubular bodies 50, 51, 52, 53 are made of a second material.

Preferably, the first material with which the main injector body 40 is made is copper or copper alloy, while the second material with which the tubular bodies 50, 51, 52, 53 are made is steel. The tubular bodies may be made of the same type of steel or of different types of steel, for example some in stainless steel and others in carbon steel.

According to a first essential aspect of the present invention, on the main injector body 40 there are obtained concentrically around the central nozzle 3 three annular shoulders 41, 42, 43 which:
are offset from one another radially and axially, and
are all in a position axially opposite the head 2.

A first annular shoulder 41 defines the bottom of the first annular chamber 10 and is axially the farthest from the head 2.

A second annular shoulder 42 defines the bottom of the second annular chamber 20 and is axially in an intermediate position between the first annular shoulder and a third annular shoulder.

A third annular shoulder 43 defines the bottom of the third annular chamber 30 and is axially the closest to the head 2.

Starting from the longitudinal axis X outward in the radial direction, there is in sequence the first annular shoulder 41, the second annular shoulder 42, and the third annular shoulder 43.

According to a further aspect of the present invention, each of the annular shoulders 41, 42, 43 has a lowered annular seat 410, 420, 430, which is arranged on the outer edge of the shoulder and acts as a centering and welding seat for the head of the respective tubular body.

Each lowered annular seat 410, 420, 430 is sized to completely house the thickness of the wall of the respective tubular body 51, 52, 53 at the head portion of the latter.

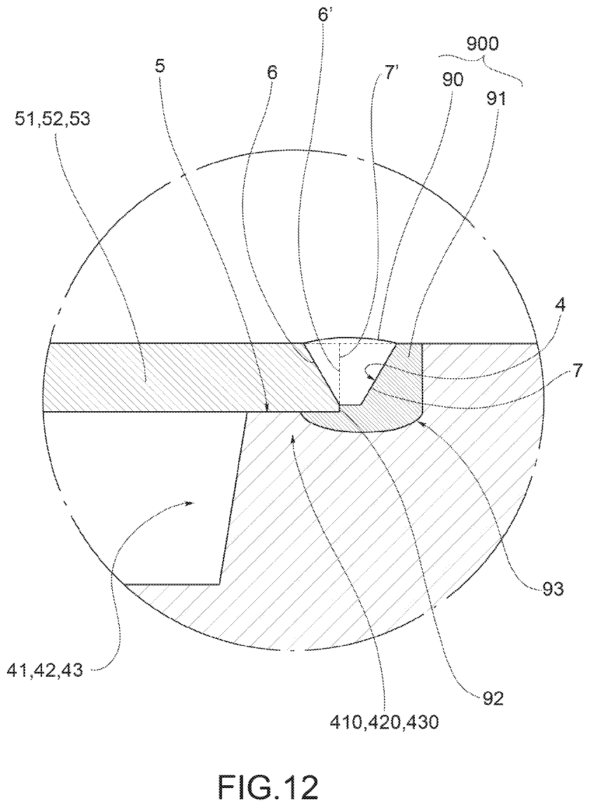

As illustrated in FIG. 12, each lowered annular seat 410, 420, 430 is defined by two surfaces incident with each other, wherein:
a first surface 4 is transverse to the longitudinal axis X and is connected by a welding bead 90 to the thickness of the wall of the tubular body at the head; and
a second surface 5 is parallel to the longitudinal axis X and at least partially faces the inner wall of the tubular body at the head.

As illustrated in FIG. 12, between the head of each tubular body and the respective lowered annular seat there is a fill 91 which:
consists of a material compatible in welding with the first material and the second material, and
occupies a recess 93 obtained on the main injector body at the lowered annular seat.

The fill 91 defines at least the first surface 4 of the lowered annular seat and extends radially inwards beyond the second surface 5.

The welding bead 90 is arranged between the head and the fill 91.

Preferably, the surface 6 of the head and the surface 7 of the fill 91 facing the welding bead 90 are chamfered.

The expression “a material compatible in welding with the first material and the second material” means a material that can be welded with both the first material and the second material.

Thanks to the invention, and in particular due to the presence of a lowered annular seat 410, 420, 430 for each annular shoulder 41, 42 and 43, the following advantages are achieved.

A first advantage relates to the ease of assembly of each tubular body 51, 52 and 53 on the main injector body 40. Each lowered annular seat 410, 420 and 430 defines, in fact, a centering seat for the respective tubular body intended to be associated with the shoulder in which the annular seat is obtained. On the one hand, this facilitates the assembly of the injector-burner 1 since the axial alignment of the tubular bodies 51, 52, 53 is guided; on the other hand, it simplifies the welding operations as no specific operative measures are required to maintain the alignment of the tubular bodies during welding.

A second advantage is related to the fact that, again thanks to the presence of the lowered annular seats 410, 420 and 430, it is possible to define in the joining area between the head of the tubular body and the main injector body 40 a weld 900 (consisting of the welding bead 90 and the fill 91) having a resistant section that extends beyond the thickness of the wall of the tubular body.

In fact, as illustrated in FIG. 12, the fill 91 on which the welding bead 90 adheres has an extension not limited by the thickness of the wall of the tubular body, but may extend inside the main injector body beneath the respective shoulder, radially beyond the second surface without affecting the shoulder itself.

Given the same wall thickness of the tubular body, this results in a greater resistant section of the weld joint.

Operationally, as is known, the welding operations of the tubular bodies on the main injector body 40 require the preheating of the tubular bodies themselves. This causes their inevitable expansion. At the end of welding, cooling causes shrinkage of the tubular body, resulting in stress generation on the weld joint. The shorter the tubular body, the smaller the length over which the shrinkage is distributed and therefore the higher the thermo-mechanical stresses and deformations on the joint during the shrinkage phenomena that occur after welding.

Given the same length of the tubular body, having a greater resistant section in the weld joint means reducing the risk of tearing of the welded joints.

Thanks to the invention, there is a greater resistant section at the welding joints. This margin can be exploited to compensate for greater shrinkage due to a reduction in the length of the tubular body.

The reduction in the length of the tubular bodies thus translates into a reduction in the overall length of the injector-burner 1, which for this reason proves to be more manageable.

Thanks to the invention, the injector-burner 1 for furnaces, for example electric arc furnaces, is more manageable, while maintaining construction features that ensure its functionality. All this is achieved without increasing the complexity of implementation, and indeed reducing it thanks to greater ease of construction.

Preferably, from a production point of view, on each annular seat a machining operation is performed which removes the first material and produces a recess 93 that extends radially inwards beyond the second surface, onto which recess 93 a fill 91 of a material compatible in welding with the first material and the second material is then deposited, which is subsequently machined to create a chamfered surface 7, and onto which the welding is then carried out, forming a welding bead 90 arranged between the head, which is in turn previously chamfered 6, and the chamfered surface 7 of the fill 91. In FIG. 12, the original lines of the surface of the head 6′ and of the fill 7′ before chamfering are shown in dashed lines.

Preferably, as already mentioned, the welding bead 90 extends between two chamfered surfaces 6 and 7, one obtained on the head of the tubular body and the other on the fill 91.

Preferably, as illustrated in FIG. 12, the fill 91 defines a stop step 92 for the head, which is not involved in the welding bead 90.

Preferably, as illustrated in FIG. 12, the fill 91 extends to at least a part of the second surface 5.

In particular, the welding may be performed, for example, using TIG or MAG technique.

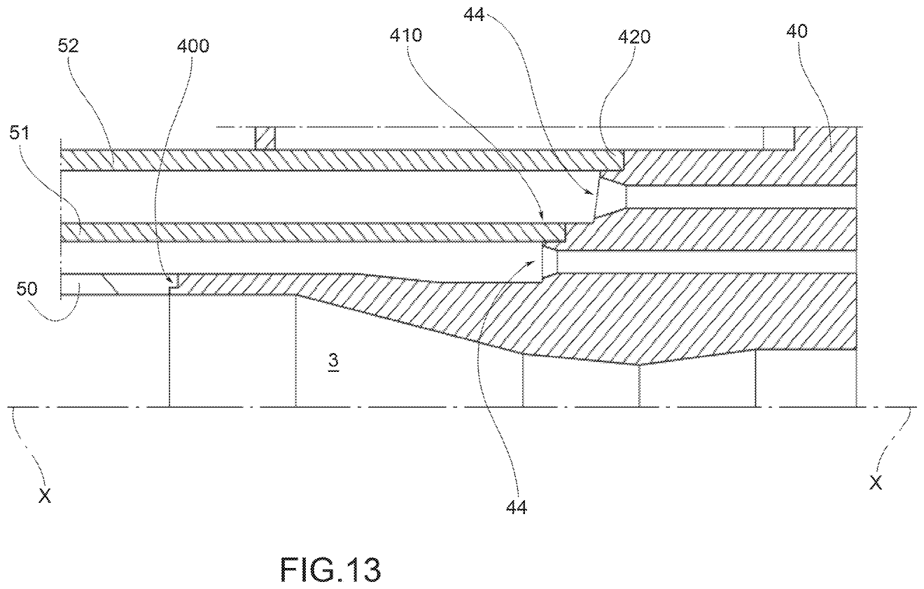

Preferably, as illustrated in FIG. 13, the head portion of the central nozzle 3 where the respective tubular body 50 (first supply duct) is joined includes a lowered annular seat 400 which is arranged on the outer edge of the head portion and acts as a centering and welding seat for the head of the respective tubular body, a weld being present between the head and the annular seat.

Advantageously, the same features provided for the joining of the other tubular bodies may also be applied to the central tubular body 50 and the central nozzle 3.

Depending on the array to which they belong, the nozzles 100, 210, 220 are open on the first annular chamber 10 or on the second annular chamber 20 respectively on the first annular shoulder 41 or on the second annular shoulder 42.

The ideal solution for the inlet of the holes from the respective annular chambers should provide for the presence of radiused chambers CR on the bottom of the annular chambers themselves, as these ensure internal uniformity of flow. However, the presence of the lowered annular seats makes the adoption of such a solution impossible.

Preferably, as illustrated in the attached figures, to mitigate the fluid dynamic limitations related to imperfect inlet conditions of the holes and to still achieve good inlet conditions and uniform filling of the holes, the first annular shoulder 41 and the second annular shoulder 42 are defined by a flat surface:
having an inclination such as to be orthogonal to the axis of each of the nozzles, if the nozzles have a single angle with respect to the longitudinal axis X, or
having an inclination defined as an intermediate value between the angles orthogonal to the axis of each of the nozzles, if the nozzles have different angles with respect to the longitudinal axis X.

In addition, on the first annular shoulder 41 and/or on the second annular shoulder 42, a mouth 44 is obtained for each nozzle.

Preferably, the mouth 44 is defined by a conical flaring of the surface defining the shoulder with an axis coincident with the axis of the nozzle.

As already highlighted previously, the first annular chamber 10 is intended to be fluidically supplied with a flow of gaseous fuel or with a flow of secondary combustion agent, while the second annular chamber 20 is intended to be fluidically supplied with a flow of secondary combustion agent, in the case where the first annular chamber 10 is supplied with a flow of gaseous fuel, or with a flow of gaseous fuel, in the case where the first annular chamber 10 is supplied with a flow of secondary combustion agent.

According to a preferred embodiment of the present invention, the first annular chamber 10 is intended to be fluidically supplied with a flow of gaseous fuel, while the second annular chamber 20 is intended to be fluidically supplied with a flow of secondary combustion agent.

As is known, once the power deliverable by the injector-burner is fixed, the outlet cross-section of the gases (including oxygen) is automatically determined.

Moreover, as is known, to ignite the flame it is necessary to leave between the holes a sufficient distance to allow the recall of hot gases from the furnace, which are the ignition source.

Traditionally, to reconcile the above two requirements, large holes are made and distributed in a single array. In order to provide sufficient space between the holes for the recall of hot gases, the diameter of the injector-burner head is increased. This is detrimental to the manageability of the injector-burner, which becomes more cumbersome.

Traditionally, a possible alternative solution involves making fewer holes but of large size. In this case, if one does not intend to increase the diameter of the head, either the recall of hot gases from the outside is allowed without, however, reaching the required power, or the recall of hot gases is sacrificed in order to reach the required power. To ensure sufficient space between the holes to allow the recall of hot gases, it is indeed necessary to reduce the number of holes at the expense of the flow cross-section; conversely, to guarantee an adequate flow cross-section to achieve the required power, the holes must be brought closer together, preventing the recall of hot gases from the outside.

Advantageously, the present invention proposes to address this issue differently from traditional solutions.

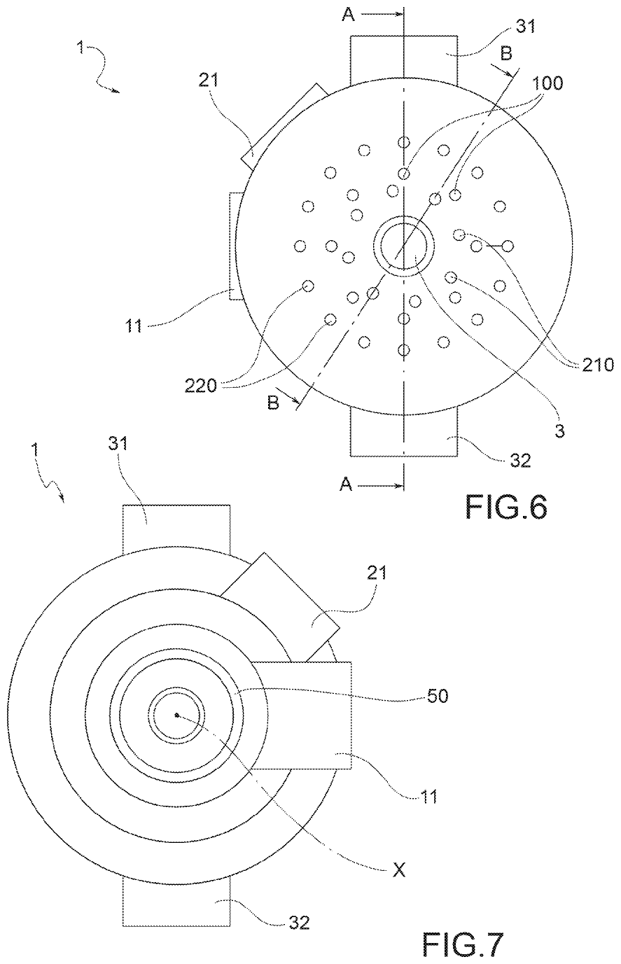

Advantageously, as illustrated in particular in FIG. 6, the head 2 is provided with:
the central nozzle 3,
a circular series of first nozzles 100 that connect the first annular chamber 10 at the first annular shoulder 41 with the outside of the injector-burner 1; and
two concentric circular series of second nozzles 210 and 220, which connect the second annular chamber 20 at the second annular shoulder 42 with the outside of the injector-burner 1.

The central nozzle 3 is aligned on the longitudinal axis X and the circular series of first nozzles 100 is intermediate between the two concentric circular series of second nozzles 210; 220.

As will be clarified hereinbelow, the choice to arrange the second nozzles in two concentric circular arrays, for a given power deliverable by the injector-burner, allows reducing the radial dimensions of the head 2 of the injector-burner while simultaneously allowing the recall of hot gases. In this way, the injector-burner 1, while ensuring full functionality, being radially smaller, proves to be even more manageable.

More specifically, an arrangement that provides for organizing the second holes in a double circular array makes available an adequate cross-section for the required power and enough space between the various holes to allow the recall of hot gases from the furnace.

This arrangement of the holes also has a further advantage. The fuel (e.g., methane) is encapsulated in a double layer of combustion agent (e.g., oxygen), ensuring complete combustion (due to the impossibility for the fuel to move radially without intersecting the combustion agent) and, particularly in the case of injector function, ensuring that the fuel burns with the combustion agent of the innermost layer without consuming the combustion agent (oxygen) supplied by the central nozzle of the injector.

Advantageously, the reduction of the radial dimensions of the head of the injector-burner 1 (for equal power delivered) allows reducing the surface of the head exposed inside the furnace. Therefore, under equal thermal conditions inside the furnace, the thermal load received by the head is reduced, making cooling easier.

Therefore, given the power to be delivered, thanks to the arrangement of the second holes in a double circular array, excessive crowding of the outermost array of second holes is avoided, not only ensuring good ignition by suction of gases from the furnace but also obtaining a “dual-stage” flame with confinement of the fuel.

Finally, the reduction of the radial dimensions of the head not only makes the injector-burner more manageable but also allows reducing the thermal load to be dissipated, thus lowering the cooling requirements.

Advantageously, the first nozzles 100 are angularly equally distributed.

Preferably, the circular series of first nozzles 100 is concentric to the central nozzle 3.

Advantageously, the first nozzles 100 may have axes with a non-zero circumferential component with respect to the longitudinal axis X. In other words, the first nozzles 100 may be configured to impart a swirl to the flow passing through them.

Advantageously, the second nozzles 210, 220 are angularly equally distributed.

Preferably, the two concentric circular series of second nozzles 210 and 220 are concentric to the central nozzle 3.

Advantageously, the second nozzles 210 of the innermost circular series may have axes with a non-zero circumferential component with respect to the longitudinal axis X. In other words, the second nozzles 210 of the innermost circular series may be configured to impart a swirl to the flow passing through them.

Advantageously, the second nozzles 220 of the outermost circular series may have axes with a non-zero circumferential component with respect to the longitudinal axis X. In other words, the second nozzles 220 of the outermost circular series may be configured to impart a swirl to the flow passing through them.

According to the preferred embodiment illustrated in the attached figures, the second nozzles 220 of the outermost circular series are in a number from 2 to 80, preferably from 6 to 48.

The first nozzles 100 (preferably intended to deliver gaseous fuel) and the second nozzles 210 of the innermost circular series (preferably intended to deliver secondary combustion agent) allow the creation of a first flame core that is stable and well enveloped, consistent with the axial flow of primary combustion agent delivered by the central nozzle 3. The second nozzles 220 of the outermost circular series (also preferably intended to deliver secondary combustion agent)—in addition to supplying the oxygen to complete the combustion—allow the creation of a stable envelope of secondary combustion agent around the above-described central flame core. In this way, it is ensured that the gaseous fuel cannot exit in any way towards the outside of the flame (at least not unmixed with oxygen), thereby avoiding the formation of dangerous pockets in the material being melted inside the furnace.

Preferably, all or part of the first nozzles 100 and the second nozzles 210 and 220 have a constant cross-section in the direction of their respective axes, for example circular, slot-shaped, or elliptical.

All or part of the first nozzles 100 and the second nozzles 210 and 220 may have a variable cross-section in the direction of their respective axes, for example convergent-divergent.

Advantageously, the central nozzle 3 has a variable cross-section in the axial direction, preferably convergent-divergent. Even more preferably, the nozzle 3 defines a De Laval nozzle, suitable for generating a supersonic flow of primary combustion agent at the outlet of the injector-burner 1, sized to produce, at the design supply pressure, a jet free from shock waves and other dissipative phenomena.

The present invention makes it possible to obtain numerous advantages, partly already described.

The injector-burner for furnaces, for example electric arc furnaces, according to the present invention can be constructed so as to be more manageable and more economical, while at the same time having construction features such as to maintain its functionality, without however increasing the complexity of implementation, and possibly even reducing it.

In particular, the injector-burner for furnaces, for example electric arc furnaces, according to the present invention can be constructed so as to reduce its longitudinal development without increasing the risk of tearing at the joining zones between tubular bodies and the main injector body.

The injector-burner for furnaces, for example electric arc furnaces, according to the present invention can be constructed so as to be more manageable and more economical, while still allowing efficient cooling of the head.

In particular, the injector-burner for furnaces, for example electric arc furnaces, according to the present invention can be constructed so as to reduce the radial development of the head without loss of deliverable power, and at the same time improving cooling of the head.

The injector-burner for furnaces, for example electric arc furnaces, according to the present invention can be constructed so as to be more manageable and more economical, while continuing to offer fluid dynamic performance favourable to combustion.

The present invention thus conceived therefore achieves the intended objects.

Obviously, it may assume, in its practical implementation, also forms and configurations different from those illustrated above without thereby departing from the present scope of protection.

Furthermore, all details may be replaced by technically equivalent elements, and the dimensions, shapes, and materials used may be of any kind, depending on requirements.

What is claimed is

1. An injector-burner for furnaces, optionally the furnaces being electric arc furnaces, having an axial-symmetric extension with respect to a longitudinal axis and defining sequentially from the longitudinal axis outwards:
a central nozzle arranged along the longitudinal axis and intended to be fluidically supplied with a flow of primary combustion agent through a first supply duct;
a first annular chamber intended to be fluidically supplied with either a flow of gaseous fuel or with a flow of secondary combustion agent through at least a second supply duct;
a second annular chamber intended to be fluidically supplied by at least a third supply duct with the flow of secondary combustion agent, in the case where the first annular chamber is fed with the flow of gaseous fuel, or with the flow of gaseous fuel, in the case where the first annular chamber is fed with the flow of secondary combustion agent; and
a third annular chamber intended to be fluidically connected to a delivery and a return of a cooling fluid circulation circuit,
wherein the first, second and third annular chambers are concentric to the central nozzle,
wherein the injector-burner comprises a main injector body on which are formed:
a head arranged at a first axial end of the injector-burner and intended to face an inside of a furnace, the head being coaxially crossed by the central nozzle and being provided with several circular series of nozzles which connect the first annular chamber and the second annular chamber with an outside of the injector-burner,
the central nozzle extending axially in a position opposite to the head;
wherein the injector-burner further comprises an assembly of four concentric tubular bodies which are sealingly connected by welding on the main injector body in positions axially and radially offset from each other to define two by two the three annular chambers,
wherein the main injector body is made of a first material, while the four concentric tubular bodies are made of a second material,
wherein on the main injector body three annular shoulders are obtained concentrically around the central nozzle, the three annular shoulders being radially and axially offset from each other, and in a position axially opposite the head, wherein:
a first annular shoulder of the three annular shoulders defines a bottom of the first annular chamber and is axially farthest from the head;
a second annular shoulder of the three annular shoulders defines a bottom of the second annular chamber and is axially in an intermediate position between the first annular shoulder and a third shoulder of the three annular shoulders; and
the third annular shoulder defines a bottom of the third annular chamber and is axially closest to the head,
wherein each shoulder of the three annular shoulders has a lowered annular seat arranged on an outer edge of the shoulder and acting as a centering and welding seat for the head of a respective tubular body,
wherein each lowered annular seat is sized to completely house a thickness of a wall of the respective tubular body at a head portion of the tubular body,
wherein each lowered annular seat is defined by two surfaces incident with each other, wherein:
a first surface of the two surfaces is transverse to the longitudinal axis and connected by a welding bead to the thickness of the wall of the tubular body at the head; and
a second surface of the two surfaces is parallel to the longitudinal axis and at least partially faces an inner wall of the tubular body at the head,
and wherein on the lowered annular seat a fill consisting of a material compatible in welding with the first material and the second material occupies a recess obtained on the main injector body at the lowered annular seat, the fill defining at least the first surface of the lowered annular seat and extending radially inwards beyond the second surface, wherein the welding bead is arranged between the head and the fill, preferably a surface of the head and a surface of the fill facing the welding bead being chamfered.

2. The injector-burner of claim 1, wherein the fill defines a stop step for the head.

3. The injector-burner of claim 1, wherein the fill extends to at least a part of the second surface.

4. The injector-burner of claim 1, wherein the first material is copper or copper alloy.

5. The injector-burner of claim 1, wherein the main injector body is made in a single piece.

6. The injector-burner of claim 1, wherein the second material is steel.

7. The injector-burner of claim 1, wherein depending on an array to which the nozzles belong, the nozzles are open on the first annular chamber or on the second annular chamber respectively on the first annular shoulder or on the second annular shoulder.

8. The injector-burner of claim 7, wherein the first annular shoulder and the second annular shoulder are defined by a flat surface
having an inclination such as to be orthogonal to an axis of each of the nozzles, if the nozzles have a single angle with respect to the longitudinal axis, or
having an inclination defined as an intermediate value between angles orthogonal to the axis of each of the nozzles, if the nozzles have different angles with respect to the longitudinal axis.

9. The injector-burner of claim 7, wherein on the first annular shoulder and/or on the second annular shoulder a mouth is obtained for each nozzle, preferably the mouth being defined by a conical flaring of a surface defining an axis shoulder coincident with an axis of the nozzle.

10. The injector-burner of claim 1, wherein:
the first annular chamber is intended to be fluidically supplied with the flow of gaseous fuel; and
the second annular chamber is intended to be fluidically supplied with the flow of secondary combustion agent.

11. The injector-burner of claim 10, wherein the head is provided with:
the central nozzle,
a circular series of first nozzles connecting the first annular chamber at the first annular shoulder with the outside of the injector-burner; and
two concentric circular series of second nozzles connecting the second annular chamber at the second annular shoulder with the outside of the injector-burner,
wherein the central nozzle is aligned on the longitudinal axis and the circular series of first nozzles is intermediate between the two concentric circular series of second nozzles.

12. The injector-burner of claim 11, wherein the first nozzles are angularly equally distributed, preferably the circular series of first nozzles being concentric to the central nozzle.

13. The injector-burner of claim 12, wherein the first nozzles have axes with non-zero circumferential components with respect to the longitudinal axis.

14. The injector-burner of claim 11, wherein the second nozzles are angularly equally distributed, and wherein the two concentric circular series of second nozzles are concentric to the central nozzle.

15. The injector-burner of claim 11, wherein the second nozzles of an innermost circular series have axes with non-zero circumferential component with respect to the longitudinal axis.

16. The injector-burner of claim 11, wherein the second nozzles of an outermost circular series have axes with non-zero circumferential component with respect to the longitudinal axis.

17. The injector-burner of claim 11, wherein all or a portion of the first nozzles and the second nozzles have a constant cross-section in a direction of their respective axes, for example a circular, slot-shaped, or elliptical cross-section.

18. The injector-burner of claim 11, wherein all or a portion of the first nozzles and the second nozzles have a variable cross-section in a direction of their respective axes, for example convergent-divergent.

19. The injector-burner of claim 1, wherein the central nozzle has a variable cross-section in an axial direction, preferably convergent-divergent.
